(19) United States
(12) Patent Application Publication
(10) Pub. No.: US 2016/0357292 A1
(43) Pub. Date: Dec. 8, 2016

(54) DISPLAY SYSTEM WITH TOUCH DETECTION FUNCTION

(71) Applicant: Japan Display Inc., Tokyo (JP)

(72) Inventors: Yuji SUZUKI, Tokyo (JP); Yoshitoshi KIDA, Tokyo (JP)

(21) Appl. No.: 15/161,758

(22) Filed: May 23, 2016

(30) Foreign Application Priority Data
Jun. 2, 2015 (JP) 2015-112348

(51) Int. Cl. G06F 3/041; G06F 3/047

(52) U.S. Cl. CPC G06F 3/0412; G06F 3/047

(57) ABSTRACT

According to an aspect, a display system with a touch detection function includes a display apparatus with a touch detection function and a pointing device. The display apparatus with a touch detection function includes: a display device; a touch detecting device including transmission electrodes and reception electrodes; and a control circuit. The pointing device holds codes of binary or more corresponding to predetermined drawing functions, detects a transmission signal transmitted from the transmission electrodes, generates a generation signal by, based on the codes, inverting and amplifying the transmission signal with an amplification factor of at least one pulse out of the pulses being different from amplification factors of other pulses, and outputs the generation signal to the reception electrodes. The control circuit identifies a code included in the generation signal and performs a drawing function corresponding to the code at the position of the pointing device on the display device.

### CROSS-REFERENCE TO RELATED APPLICATIONS

This application claims priority from Japanese Application No. 2015-112348, filed on Jun. 2, 2015, the contents of which are incorporated by reference herein in its entirety.

### BACKGROUND

1. Technical Field

The present invention relates to a display system with a touch detection function.

2. Description of the Related Art

Display apparatuses with a touch detection function have recently been attracting attention. Such display apparatuses are obtained by mounting a contact detecting device called a touch panel on a display device, such as a liquid-crystal display device, or integrating the touch panel with the display device. The display apparatuses display various button images and other images on the display device instead of typical mechanical buttons to receive information. Because the display apparatuses with a touch panel require no input device, such as a keyboard, a mouse, or a keypad, they are increasingly used for computers, portable electronic apparatuses, such as mobile phones, and other equipment.

Some types of touch detection technologies are known, including capacitive touch panels that require low power consumption. Display apparatuses with a touch detection function including such a capacitive touch panel, for example, may have the following configuration: common electrodes for display originally included in the display apparatuses are also used as one of a pair of touch sensor electrodes, and the other of the electrodes (touch detection electrodes) is arranged in a manner intersecting with the common electrodes. The display apparatuses with a touch detection function sequentially apply drive signals to the common electrodes to perform linear sequential scanning, thereby performing a display operation. In addition, based on the fact that capacitance formed between the pair of touch sensor electrodes changes depending on an external proximity object, the display apparatuses with a touch detection function analyze touch detection signals generated in the touch detection electrodes in response to the drive signals, thereby performing a touch detection operation.

In display systems with a touch detection function including such a touch panel, a user may perform a touch operation using a finger or a pointing device, such as a stylus pen (an active pen or an electronic pen). Especially in a large touch panel system called an interactive whiteboard used in presentations and lectures for a large number of people, a user may perform a certain operation, such as drawing, with an electric pen held in one hand while performing another operation by a finger of the other hand. Alternatively, one user may perform a certain operation with an electric pen held in the hand, and another user with no electric pen may perform a certain operation by a finger. Japanese Patent Application Laid-open Publication No. 2012-22543, for example, discloses a touch panel system that allows a plurality of electronic pens and fingers to simultaneously perform touch operations, reliably identifies these indication objects, and has excellent usability without a limit on the number of simultaneously available electronic pens.

By contrast, small electronic apparatuses, such as personal computers, tablets, and smartphones, are basically used by a single user. Such small electronic apparatuses are each generally operated with one stylus pen and are each required to have what is called a palm rejection function and/or an additional function. The palm rejection function is a function to distinguish a hand holding a stylus pen from the stylus pen and reject a touch operation performed by the hand holding the stylus pen. The additional function is, for example, a function to provide a plurality of types of functions to one stylus pen or reflect the operating state of the stylus pen. To perform these functions, a wireless communication function, such as Bluetooth (registered trademark), is generally used. In this case, the stylus pen needs to have a wireless communication function other than the touch operation.

For the foregoing reasons, there is a need for a display system with a touch detection function that can perform various types of functions of one pointing device having a plurality of types of functions simply by a touch operation.

### SUMMARY

According to an aspect, a display system with a touch detection function includes a display apparatus with a touch detection function and a pointing device. The display apparatus with a touch detection function includes: a display device; a touch detecting device that faces the display device and includes a plurality of transmission electrodes arranged side by side in a manner extending in one direction and a plurality of reception electrodes arranged side by side in a manner extending in a direction intersecting with the transmission electrodes, capacitance being formed between the transmission electrodes and the reception electrodes; and a control circuit that outputs a transmission signal including a plurality of pulses having the same peak value to the transmission electrodes and detects a position of at least the pointing device on the touch detecting device based on a reception signal received from each of the reception electrodes to display the position on the display device. The pointing device is used to indicate the position on the touch detecting device. The pointing device holds a plurality of codes of binary or more corresponding to a plurality of predetermined drawing functions performable on the display device, detects the transmission signal transmitted from the transmission electrodes, generates a generation signal by, based on the codes, inverting and amplifying the transmission signal with an amplification factor of at least one pulse out of the pulses being different from amplification factors of other pulses, and outputs the generation signal to the reception electrodes. The control circuit identifies a code included in the generation signal and performs a drawing function corresponding to the code at the position of the pointing device on the display device.

### BRIEF DESCRIPTION OF THE DRAWINGS

FIGS. 1A and 1B are diagrams for explaining the basic principle of a touch detection technology employed by a display system with a touch detection function according to a first embodiment and illustrate a state where no finger or no pointing device is in contact with or in proximity to a touch sensor;

FIGS. 2A and 2B are diagrams for explaining the basic principle of the touch detection technology employed by the display system with a touch detection function according to the first embodiment and illustrate a state where a finger is in contact with or in proximity to the touch sensor;

FIGS. 3A and 3B are diagrams for explaining the basic principle of the touch detection technology employed by the display system with a touch detection function according to the first embodiment and illustrate a state where a typical pointing device is in contact with or in proximity to the touch sensor;

FIG. 4 is a diagram for explaining the basic principle of the touch detection technology employed by the display system with a touch detection function according to the first embodiment and illustrate an example of waveforms of a drive signal and a touch detection signal;

FIG. 5 is a diagram of an exemplary configuration of a display apparatus with a touch detection function in the display system with a touch detection function according to the first embodiment;

FIG. 6 is a schematic view of an exemplary sectional structure of a major part of a display device with a touch detection function;

FIG. 7 is a diagram of an exemplary configuration of a pixel structure in a liquid-crystal display device;

FIG. 8 is a perspective view of an exemplary configuration of a touch detecting device;

FIG. 9 is a diagram of an exemplary schematic configuration of the display system with a touch detection function according to the first embodiment;

FIG. 10 is a diagram of an example of a transmission signal Tx output from a touch control circuit in the display system with a touch detection function according to the present embodiment;

FIG. 11 is a diagram of an exemplary configuration of a pointing device in the display system with a touch detection function according to the first embodiment;

FIG. 12 is a diagram of an example of drawing functions that can be performed on the liquid-crystal display device and an example of codes and generation signals ARx corresponding to the respective drawing functions;

FIG. 13 is a diagram of an exemplary configuration of a code applying unit according to the first embodiment;

FIG. 14 is a diagram of an exemplary configuration of the touch control circuit in the display system with a touch detection function according to the first embodiment;

FIG. 15 is a flowchart of an example of a specific process performed by the display system with a touch detection function according to the first embodiment;

FIG. 16 is a diagram of an exemplary configuration of a pointing device in the display system with a touch detection function according to a second embodiment;

FIG. 17 is a diagram of an exemplary configuration of a code applying unit according to the second embodiment;

FIG. 18 is a diagram of an exemplary configuration of a pointing device in the display system with a touch detection function according to a third embodiment;

FIG. 19 is a diagram of an exemplary configuration of a code applying unit according to the third embodiment;

FIG. 20 is a diagram of an exemplary schematic configuration of a display system with a touch detection function according to a fourth embodiment;

FIG. 21 is a diagram of an exemplary configuration of a pointing device in the display system with a touch detection function according to the fourth embodiment;

FIG. 22 is a diagram of an exemplary configuration of a code application signal generating unit according to the fourth embodiment; and

FIG. 23 is a diagram of an exemplary configuration of a touch control circuit in the display system with a touch detection function according to the fourth embodiment.

### DETAILED DESCRIPTION

Exemplary embodiments according to the present invention are described below in greater detail with reference to the accompanying drawings. The contents described in the embodiments are not intended to limit the present invention. Components described below include components easily conceivable by those skilled in the art and components substantially identical therewith. Furthermore, the components described below can be appropriately combined. The disclosure is given by way of example only, and various changes made without departing from the spirit of the invention and easily conceivable by those skilled in the art naturally fall within the scope of the invention. The drawings may possibly illustrate the width, the thickness, the shape, and other elements of each unit more schematically than the actual aspect to simplify the explanation. These elements, however, are given by way of example only and are not intended to limit interpretation of the invention. In the specification and the accompanying drawings, components similar to those previously described with reference to a preceding drawing are denoted by the same reference numerals and symbols, and overlapping explanation thereof will be appropriately omitted.

### First Embodiment

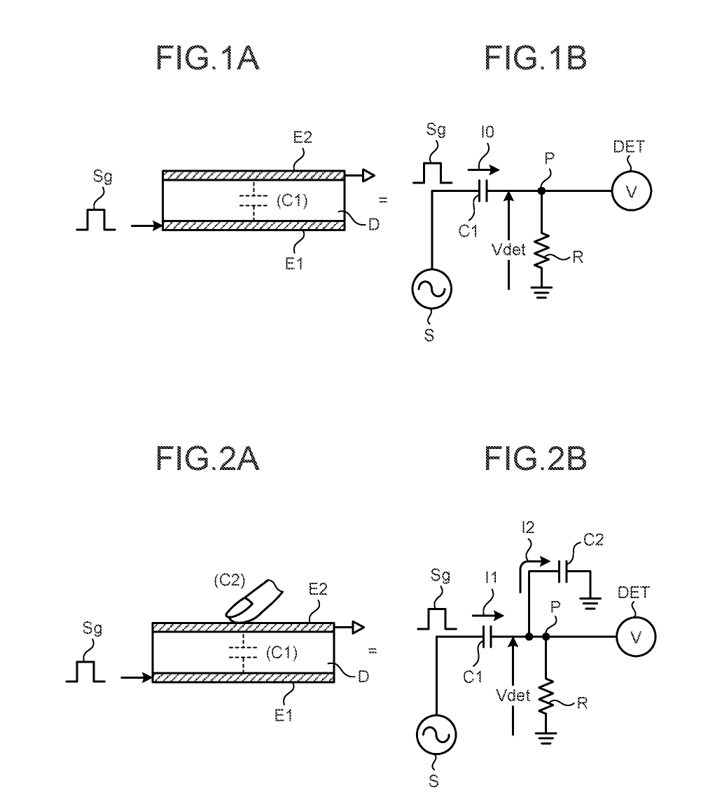

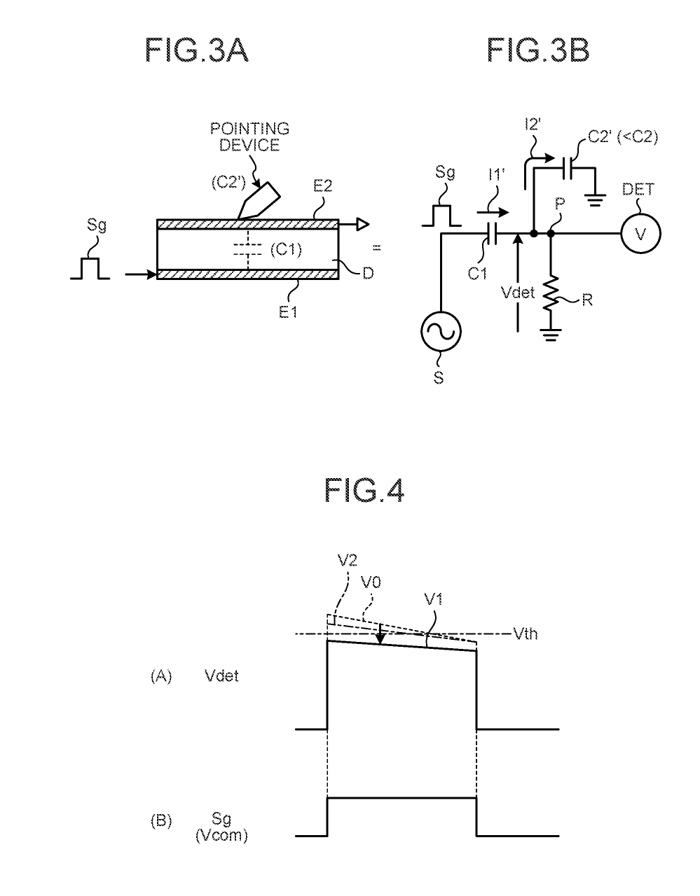

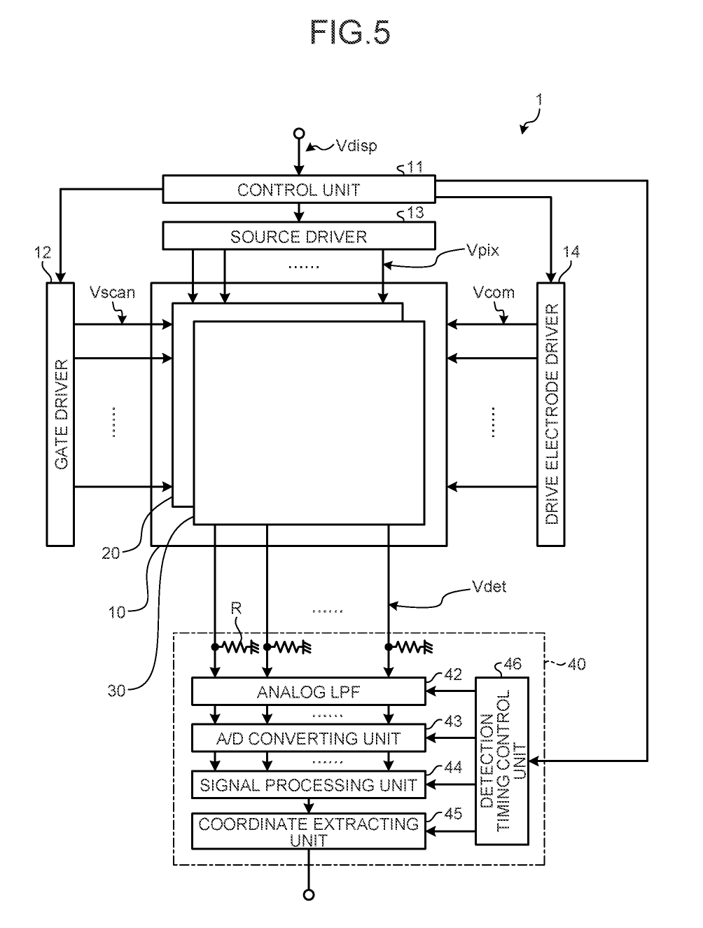

The following describes the basic principle of touch detection performed by a display system with a touch detection function according to a first embodiment with reference to FIGS. 1A, 1B, 2A, 2B, 3A, 3B, and 4. FIGS. 1A and 1B are diagrams for explaining the basic principle of the touch detection technology employed by the display system with a touch detection function according to the first embodiment and illustrate a state where no finger or no pointing device is in contact with or in proximity to a touch sensor. FIGS. 2A and 2B are diagrams for explaining the basic principle of the touch detection technology employed by the display system with a touch detection function according to the first embodiment and illustrate a state where a finger is in contact with or in proximity to the touch sensor. FIGS. 3A and 3B are diagrams for explaining the basic principle of the touch detection technology employed by the display system with a touch detection function according to the first embodiment and illustrate a state where a typical pointing device is in contact with or in proximity to the touch sensor. FIG. 4 is a diagram for explaining the basic principle of the touch detection technology employed by the display system with a touch detection function according to the first embodiment and illustrates an example of waveforms of a drive signal and a touch detection signal.

The touch detection technology employed by the display system with a touch detection function according to the first embodiment is embodied as a capacitive touch sensor. As illustrated in FIG. 1A, for example, a capacitive element includes a pair of electrodes (a drive electrode E1 and a touch detection electrode E2) arranged facing each other with a dielectric D interposed therebetween. This structure is represented by an equivalent circuit in FIG. 1B. A capacitive element C1 includes the drive electrode E1, the touch detection electrode E2, and the dielectric D. A first end of the capacitive element C1 is coupled to an alternating-current (AC) signal source (drive signal source) S, whereas a second end P thereof is grounded via a resistor R and coupled to a voltage detector (touch detection circuit) DET. When the AC signal source S applies an AC rectangular wave Sg ((B) of FIG. 4) at a predetermined frequency (e.g., approximately several kilohertz to ten-odd kilohertz) to the drive electrode E1 (first end of the capacitive element C1), an output waveform (touch detection signal Vdet) of (A) illustrated in FIG. 4 is generated in the touch detection electrode E2 (second end P of the capacitive element C1). The AC rectangular wave Sg corresponds to a drive signal Vcom, which will be described later. The touch detection technology according to the first embodiment is, for example, a mutual-type touch detection technology for detecting position coordinates of a detection target based on a change in the capacitance between the drive electrode E1 and the touch detection electrode E2.

In a state where a finger or a pointing device, such as a stylus pen and an active pen, is not in contact with (or in proximity to) the touch sensor (hereinafter, also referred to as a “non-touch state”), an electric current I0 depending on the capacitance value of the capacitive element C1 flows with charge and discharge of the capacitive element C1 as illustrated in FIG. 1B. The electric potential waveform at the second end P of the capacitive element C1 at this time is indicated by a waveform V0 of (A) in FIG. 4, for example, and is detected by the voltage detector DET.

In a state where a finger is in contact with (or in proximity to) the touch sensor (hereinafter, also referred to as a “touch state” created by a finger), a capacitive element C2 generated by the finger is added in series to the capacitive element C1 as illustrated in FIG. 2B. In this state, electric currents I1 and I2 flow with charge and discharge of the capacitive elements C1 and C2, respectively. The electric potential waveform at the second end P of the capacitive element C1 at this time is indicated by a waveform V1 of (A) in FIG. 4, for example, and is detected by the voltage detector DET. The electric potential at the point P is a voltage-divided potential determined based on the electric currents I1 and I2 flowing through the capacitive elements C1 and C2, respectively. As a result, the waveform V1 has a value smaller than that of the waveform V0 in the non-contact state. The voltage detector DET compares the detected voltage with a predetermined threshold voltage Vth. If the detected voltage is equal to or higher than the threshold voltage Vth, the voltage detector DET determines that the touch sensor is in the non-touch state. By contrast, if the detected voltage is lower than the threshold voltage, the voltage detector DET determines that the touch sensor is in the touch state. With this operation, the voltage detector DET can detect a touch. In the example illustrated in FIG. 2B, the capacitive element C2 is added in series to the capacitive element C1 as described above. In the case of a small-signal equivalent circuit, the capacitive element C2 is added in parallel to the capacitive element C1.

By contrast, in a state where a pointing device, such as a stylus pen and an active pen, having a small contact area is in contact with (or in proximity to) the touch sensor (hereinafter, also referred to as a “touch state” created by a pointing device), a capacitive element C2′ generated by the pointing device is added in series to the capacitive element C1 as illustrated in FIG. 3B. In this state, electric currents I1′ and I2′ flow with charge and discharge of the capacitive elements C1 and C2′, respectively. The electric potential waveform at the second end P of the capacitive element C1 at this time is indicated by a waveform V2 of (A) in FIG. 4, for example, and is detected by the voltage detector DET. The electric potential at the point P is a voltage-divided potential determined based on the electric currents I1′ and I2′ flowing through the capacitive elements C1 and C2′, respectively. The capacitive value of the capacitive element C2′ generated in the touch state created by the pointing device is smaller than that of the capacitive element C2 generated in the touch state created by the finger (C2′<C2). As a result, the waveform V2 has a value smaller than that of the waveform V0 in the non-touch state and larger than that of the waveform V1 in the touch state created by the finger. In other words, the difference between the waveform V2 in the touch state created by the pointing device and the waveform V0 in the non-touch state is smaller than that between the waveform V1 in the touch state created by the finger and the waveform V0 in the non-touch state. When the voltage detector DET compares the detected voltage with the threshold voltage Vth, the detected voltage may possibly be equal to or higher than the threshold voltage as illustrated in FIG. 4. As a result, the voltage detector DET may possibly erroneously determine that the touch sensor is in the non-touch state.

To address this, the pointing device according to the present embodiment receives the AC rectangular wave Sg applied from the AC signal source S to the drive electrode E1, inverts and amplifies it, and outputs the inverted and amplified AC rectangular wave Sg. This processing reduces the voltage-divided potential at the point P determined based on the values of the electric currents I1′ and I2′ flowing through the capacitive elements C1 and C2′, respectively. The reduction in the voltage-divided potential increases the difference between the waveform V2 in the touch state created by the pointing device and the waveform V0 in the non-touch state. In other words, with respect to the pointing device according to the present embodiment, the inverting amplification factor of the received AC rectangular wave Sg is set so as to make the voltage detected by the voltage detector DET lower than the threshold voltage when the voltage detector DET compares the detected voltage with the threshold voltage Vth. This configuration makes it possible to reliably detect the touch state created by the pointing device.

FIG. 5 is a diagram of an exemplary configuration of a display apparatus with a touch detection function in the display system with a touch detection function according to the first embodiment. Because a drive circuit and a driving method of a display apparatus 1 with a touch detection function are embodied by the present embodiment, they will also be explained. The display apparatus 1 with a touch detection function includes liquid-crystal display elements as display elements. The display apparatus 1 with a touch detection function is what is called an in-cell apparatus in which a liquid-crystal display device including the liquid-crystal display elements is integrated with a capacitive touch detecting device.

The display apparatus 1 with a touch detection function includes a control unit 11, a gate driver 12, a source driver 13, a drive electrode driver 14, a display device 10 with a touch detection function, and a touch detection circuit 40.

The control unit 11 is a circuit that supplies control signals to the gate driver 12, the source driver 13, the drive electrode driver 14, and the touch detection circuit 40 based on video signals Vdisp supplied from the outside, thereby performing control such that these components operate in synchronization with one another.

The gate driver 12 has a function to sequentially select one horizontal line to be a target of display drive in the display device 10 with a touch detection function based on the control signal supplied from the control unit 11. Specifically, the gate driver 12 applies a scanning signal Vscan to gates of TFT elements Tr of pixels Pix via a scanning signal line GCL, which will be described later. The gate driver 12 thus sequentially selects one row (one horizontal line) out of the pixels Pix arranged in a matrix on a liquid-crystal display device 20 of the display device 10 with a touch detection function as a target of display drive.

The source driver 13 is a circuit that supplies pixel signals Vpix to the pixels Pix (described later) of the display device 10 with a touch detection function based on the control signal supplied from the control unit 11. Specifically, the source driver 13 supplies, via pixel signal lines SGL, the pixel signals Vpix to the pixels Pix included in one horizontal line sequentially selected by the gate driver 12, which will be described later. Based on the supplied pixel signals Vpix, the pixels Pix perform display of one horizontal line.

The drive electrode driver 14 is a circuit that supplies a drive signal Vcom to a drive electrode COML (described later) of the display device 10 with a touch detection function based on the control signal supplied from the control unit 11. Specifically, the drive electrode driver 14 drives each drive electrode COML individually. To perform a display operation, the drive electrode driver 14 supplies a display drive signal Vcomd. By contrast, to perform a touch detection operation, the drive electrode driver 14 supplies a touch detection drive signal Vcomt. In the touch detection operation, the drive electrode driver 14 sequentially applies the touch detection drive signal Vcomt to a plurality of drive electrodes COML in a time-division manner, thereby sequentially selecting the drive electrode COML on which the touch detection operation is performed. A touch detecting device 30 outputs touch detection signals Vdet of each drive electrode COML from a plurality of touch detection electrodes TDL (described later) and supplies them to the touch detection circuit 40.

The display device 10 with a touch detection function is a display device having a touch detection function. The display device 10 with a touch detection function includes the liquid-crystal display device 20 and the touch detecting device 30. The liquid-crystal display device 20 sequentially scans one horizontal line based on a gate signal supplied from the gate driver 12, thereby performing display, which will be described later. The touch detecting device 30 operates based on the basic principle of capacitive touch detection described above, thereby outputting the touch detection signal Vdet. The touch detecting device 30 sequentially scans each drive electrode COML based on the drive signal Vcom output from the drive electrode driver 14, thereby performing touch detection, which will be described later.

The touch detection circuit 40 detects whether a touch is made on the touch detecting device 30 based on the control signal supplied from the control unit 11 and the touch detection signal Vdet supplied from the touch detecting device 30 of the display device 10 with a touch detection function. If a touch is made, the touch detection circuit 40 obtains the coordinates and the like in a touch detection region. The touch detection circuit 40 includes an analog low-pass filter (LPF) 42, an analog/digital (A/D) converting unit 43, a signal processing unit 44, a coordinate extracting unit 45, and a detection timing control unit 46. The analog LPF 42 is a low-pass analog filter that removes high-frequency components (noise components) included in the touch detection signal Vdet supplied from the touch detecting device 30 and extracts and outputs a touch component. Resistances R are coupled between respective input terminals of the analog LPF 42 and the ground to supply a direct-current (DC) potential (0 V). The DC potential (0 V) may be supplied by providing a switch instead of the resistances R, for example, and turning on the switch at predetermined time. The A/D converting unit 43 is a circuit that converts an analog signal output from the analog LPF 42 into a digital signal. The signal processing unit 44 is a logic circuit that detects whether a touch is made on the touch detecting device 30 based on the output signal from the A/D converting unit 43. The coordinate extracting unit 45 is a logic circuit that derives the touch panel coordinate when a touch is detected by the signal processing unit 44. The detection timing control unit 46 performs control such that these circuits operate in synchronization with one another. The touch detection circuit 40 outputs the touch panel coordinate extracted by the coordinate extracting unit 45 as touch detection positional information.

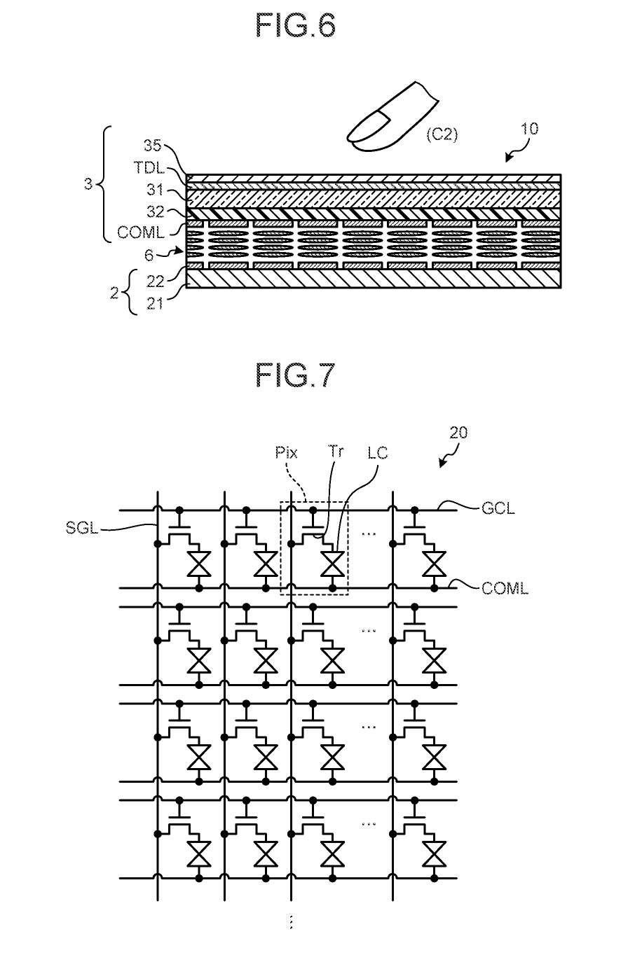

The following describes an exemplary configuration of the display device 10 with a touch detection function in detail. FIG. 6 is a schematic view of an exemplary sectional structure of a major part of the display device 10 with a touch detection function. The display device 10 with a touch detection function includes a pixel substrate 2, a counter substrate 3, and a liquid-crystal layer 6. The counter substrate 3 is arranged facing the pixel substrate 2, and the liquid-crystal layer 6 is inserted between the pixel substrate 2 and the counter substrate 3.

The pixel substrate 2 includes a TFT substrate 21 serving as a circuit board and a plurality of pixel electrodes 22 arranged in a matrix on the TFT substrate 21. The TFT substrate 21 is provided with thin-film transistors (TFTs) of the respective pixels and wiring, such as the pixel signal lines SGL and the scanning signal lines GCL, which are not illustrated. The pixel signal lines SGL supply the pixel signals Vpix to the pixel electrodes 22, and the scanning signal lines GCL drive the TFTs.

The counter substrate 3 includes a glass substrate 31, a color filter 32 formed on one surface of the glass substrate 31, and a plurality of drive electrodes COML formed on the color filter 32. The color filter 32 includes periodically arrayed color filter layers of three colors of red (R), green (G), and blue (B), for example. Each display pixel is provided with a color filter layer for a set of three colors: R, G, and B. The drive electrodes COML function not only as common drive electrodes of the liquid-crystal display device 20 but also as drive electrodes of the touch detecting device 30. The drive electrodes COML are coupled to the TFT substrate 21 by a contact conductive pillar, which is not illustrated. The TFT substrate 21 applies the drive signal Vcom (the display drive signal Vcomd and the touch detection drive signal Vcomt) having an AC rectangular waveform to the drive electrodes COML via the contact conductive pillar. While one drive electrode COML corresponds to one pixel electrode 22 in FIG. 6, the configuration is not limited thereto. Alternatively, one drive electrode COML may correspond to two pixel electrodes 22 or three or more pixel electrodes 22. The touch detection electrodes TDL serving as detection electrodes of the touch detecting device 30 are formed on the other surface of the glass substrate 31. A polarization plate 35 is provided on the touch detection electrodes TDL.

The liquid-crystal layer 6 modulates light passing therethrough depending on the state of an electric field. Examples of the liquid-crystal layer 6 include liquid crystals in various types of modes, such as a twisted nematic (TN) mode, a vertical alignment (VA) mode, and an electrically controlled birefringence (ECB) mode.

An orientation film is provided between the liquid-crystal layer 6 and the pixel substrate 2 and between the liquid-crystal layer 6 and the counter substrate 3. An incident-side polarization plate is arranged on the lower surface of the pixel substrate 2. The orientation film and the incident-side polarization plate are not illustrated in FIG. 6.

FIG. 7 is a diagram of an exemplary configuration of the pixel structure in the liquid-crystal display device 20. The liquid-crystal display device 20 includes a plurality of pixels Pix arranged in a matrix. The pixels Pix each include the TFT element Tr and a liquid-crystal element LC. The TFT element Tr is a thin-film transistor and is an n-channel metal oxide semiconductor (MOS) TFT in this example. The source of the TFT element Tr is coupled to the pixel signal line SGL, the gate thereof is coupled to the scanning signal line GCL, and the drain thereof is coupled to a first end of the liquid-crystal element LC. The first end of the liquid-crystal element LC is coupled to the drain of the TFT element Tr, and a second end thereof is coupled to the drive electrode COML.

The pixel Pix is coupled to other pixels Pix belonging to the same row in the liquid-crystal display device 20 by the scanning signal line GCL. The scanning signal line GCL is coupled to the gate driver 12 and is supplied with the scanning signal Vscan from the gate driver 12. The pixel Pix is also coupled to other sub-pixels Pix belonging to the same column in the liquid-crystal display device 20 by the pixel signal line SGL. The pixel signal line SGL is coupled to the source driver 13 and is supplied with the pixel signal Vpix from the source driver 13.

The pixel Pix is also coupled to the other pixels Pix belonging to the same row in the liquid-crystal display device 20 by the drive electrode COML. The drive electrode COML is coupled to the drive electrode driver 14 and is supplied with the drive signal Vcom (the display drive signal Vcomd or the touch detection drive signal Vcomt) from the drive electrode driver 14. In other words, one drive electrode COML is shared by a plurality of pixels Pix belonging to the same row in this example. Alternatively, one drive electrode COML may be shared by a plurality of pixels Pix belonging to a plurality of rows (two rows, for example).

With this configuration, the gate driver 12 drives to line-sequentially scan the scanning signal line GCL in the liquid-crystal display device 20 in a time-division manner, thereby sequentially selecting one horizontal line. The source driver 13 supplies the pixel signals Vpix to the pixels Pix belonging to the horizontal line, thereby performing display of each horizontal line. To perform the display operation, the drive electrode driver 14 applies the display drive signal Vcomd to the drive electrode COML corresponding to the horizontal line.

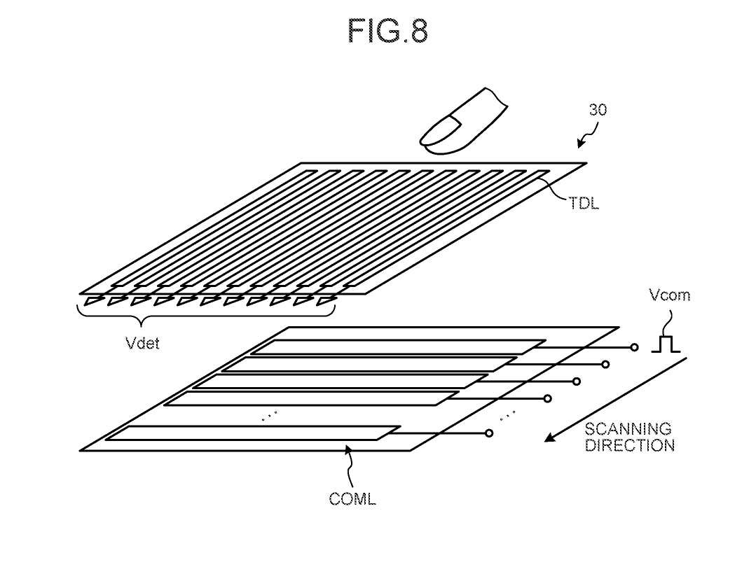

FIG. 8 is a perspective view of an exemplary configuration of the touch detecting device 30. The touch detecting device 30 includes the drive electrodes COML and the touch detection electrodes TDL included in the counter substrate 3. The drive electrodes COML are a plurality of stripe electrode patterns extending in the lateral direction in FIG. 8. To perform a touch detection operation, the drive electrode driver 14 sequentially supplies the touch detection drive signal Vcomt to the electrode patterns, thereby performing sequential linear scanning drive. The touch detection electrodes TDL are stripe electrode patterns extending in a direction orthogonal to the extending direction of the electrode patterns of the drive electrodes COML. The electrode patterns of the touch detection electrodes TDL are coupled to respective input terminals of the analog LPF 42 of the touch detection circuit 40. The electrode patterns of the drive electrodes COML and the touch detection electrodes TDL intersecting with each other have capacitance at the intersections.

To perform a touch detection operation, the drive electrode driver 14 drives to perform sequential linear scanning, thereby sequentially selecting the drive electrode COML in the touch detecting device 30. The touch detection electrodes TDL output the touch detection signals Vdet, thereby performing touch detection on each drive electrode COML. In other words, the drive electrodes COML correspond to the drive electrode E1 in the basic principle of touch detection illustrated in FIGS. 1A and 1B to 4, whereas the touch detection electrodes TDL correspond to the touch detection electrode E2. The touch detecting device 30 detects a touch according to the basic principle. As illustrated in FIG. 8, the electrode patterns intersecting with each other serve as a capacitive touch sensor formed in a matrix. By scanning the entire touch detection surface of the touch detecting device 30, it is possible to detect the position at which an external proximity object is in contact with or in proximity to the touch detecting device 30.

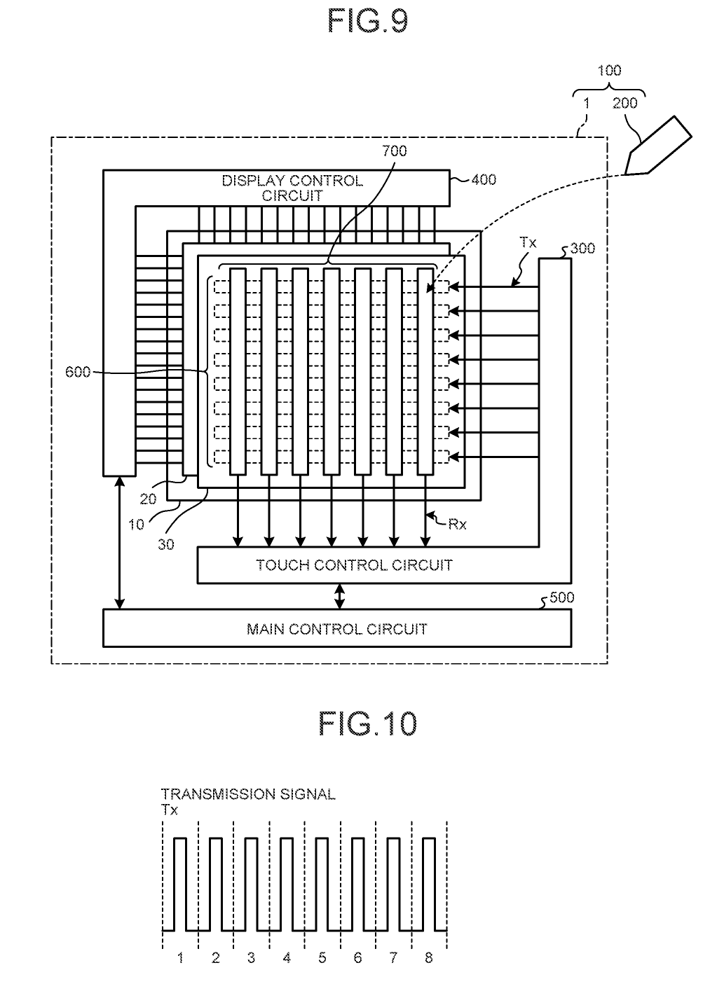

The following describes a schematic configuration and components of the display system with a touch detection function according to the present embodiment. FIG. 9 is a diagram of an exemplary schematic configuration of the display system with a touch detection function according to the first embodiment.

A display system 100 with a touch detection function according to the first embodiment includes the display apparatus 1 with a touch detection function illustrated in FIG. 5 and a pointing device 200 used to indicate a position on the touch detecting device 30. In the example illustrated in FIG. 9, a part of the configuration described with reference to FIGS. 5 to 8 is replaced to simplify the explanation. In the example illustrated in FIG. 9, a touch control circuit 300 includes the drive electrode driver 14 and the touch detection circuit 40 illustrated in FIG. 5. A display control circuit 400 includes the gate driver 12 and the source driver 13 illustrated in FIG. 5. A main control circuit 500 includes the control unit 11 illustrated in FIG. 5. In the example illustrated in FIG. 9, transmission electrodes 600 correspond to the drive electrodes COML illustrated in FIG. 8, and transmission signals Tx correspond to the drive signals Vcom illustrated in FIGS. 5 and 8. Reception electrodes 700 correspond to the touch detection electrodes TDL illustrated in FIG. 8, and reception signals Rx correspond to the touch detection signals Vdet illustrated in FIGS. 5 and 8. In the example illustrated in FIGS. 5 to 8, the display drive signal Vcomd is supplied to the drive electrodes COML to perform a display operation. In the following description with reference to FIG. 9, explanation of the display operation will be omitted.

The touch control circuit 300, the display control circuit 400, and the main control circuit 500 are an example of a “control circuit” according to the present invention.

As described above, the touch detecting device 30 according to the present embodiment is a mutual-type touch detecting device. The touch detecting device 30 performs a touch detection operation by: sequentially applying touch detection drive signals Vcomt (transmission signals Tx in this example) to the drive electrodes COML (transmission electrodes 600) in a time-division manner, and receiving the touch detection signals Vdet (reception signals Rx) output from the touch detection electrodes TDL (reception electrodes 700) intersecting with the transmission electrodes 600. FIG. 10 is a diagram of an example of the transmission signals Tx output from the touch control circuit in the display system with a touch detection function according to the present embodiment. In the present embodiment, the transmission signals Tx output from the touch control circuit 300 is a pulse waveform signal including a plurality of pulses having the same (substantially the same) peak value as illustrated in FIG. 10. While the number of pulses in the transmission signals Tx is eight in the example illustrated in FIG. 10, the number is not limited thereto.

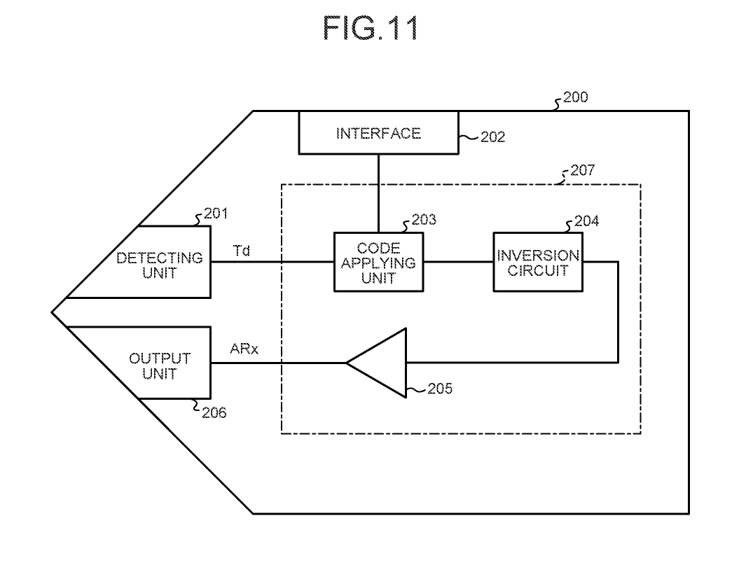

FIG. 11 is a diagram of an exemplary configuration of the pointing device in the display system with a touch detection function according to the first embodiment. The pointing device 200 includes a detecting unit 201, an interface 202, a code applying unit 203, an inversion circuit 204, an amplification circuit 205, and an output unit 206. The code applying unit 203, the inversion circuit 204, and the amplification circuit 205 serve as a signal generating unit 207 that generates a generation signal ARx including a multiple-valued code corresponding to a drawing function to be performed on the liquid-crystal display device 20.

The detecting unit 201 is provided to the tip of the pointing device 200 that is made to face the touch detecting device 30. The detecting unit 201 detects changes in the electric potential of the transmission signals Tx applied to the transmission electrodes 600 and outputs a detection transmission signal Td to the code applying unit 203.

The interface 202 is used by a user to set a drawing function desired to be performed on the liquid-crystal display device 20 by performing a touch operation on the touch detecting device 30 with the pointing device 200.

The code applying unit 203 holds a plurality of codes corresponding to the drawing functions that can be performed on the liquid-crystal display device 20. In each of the codes, a pulse the amplification factor of which is to be reduced is determined in advance out of the pulses included in the transmission signal Tx illustrated in FIG. 10.

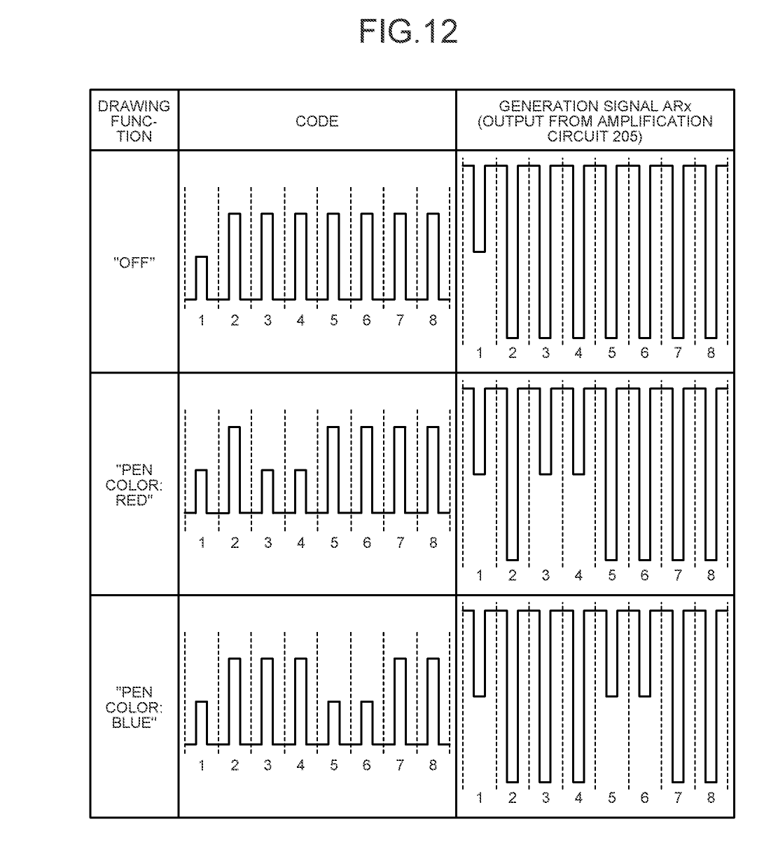

FIG. 12 is a diagram of an example of drawing functions that can be performed on the liquid-crystal display device and an example of codes and generation signals ARx corresponding to the respective drawing functions.

The following describes an example where the drawing function that can be performed on the liquid-crystal display device 20 is the selection of the color of a line drawn as a trajectory on the liquid-crystal display device 20 corresponding to the touch detection position of the pointing device 200 on the touch detecting device 30.

The interface 202 may include a simple display screen for displaying a color palette and an interface for selecting a color and may be used to select a color of a trajectory on the liquid-crystal display device 20 corresponding to a touch detection position of the pointing device 200 on the touch detecting device 30, for example. If no color is selected through the interface 202, for example, the code applying unit 203 selects a code indicating a drawing function “OFF”. In this case, the code applying unit 203 outputs a code in which only the peak value of the pulse “1” is smaller than those of the other pulses in the transmission signal Tx illustrated in FIG. 10. This code makes the amplification factor of the pulse “1” in the generation signal ARx output from the amplification circuit 205 smaller than those of the other pulses.

As described above, when no drawing function is selected, the pointing device 200 makes the amplification factor of at least one pulse in the generation signal ARx smaller. This operation makes it possible to indicate that the touch operation at the touch detection position detected by the touch detection circuit 40 is performed by the pointing device 200.

If “red” is selected through the interface 202, for example, the code applying unit 203 selects a code indicating a drawing function “pen color: red”. The code applying unit 203 outputs a signal in which the peak values of the pulses “1”, “3”, and “4” are smaller than those of the other pulses in the transmission signal Tx illustrated in FIG. 10. This signal makes the amplification factors of the pulses “1”, “3”, and “4” in the generation signal ARx output from the amplification circuit 205 smaller than those of the other pulses.

If “blue” is selected through the interface 202, for example, the code applying unit 203 selects a code indicating a drawing function “pen color: blue”. The code applying unit 203 outputs a signal in which the peak values of the pulses “1”, “5”, and “6” are smaller than those of the other pulses in the transmission signal Tx illustrated in FIG. 10. This signal makes the amplification factors of the pulses “1”, “5”, and “6” in the generation signal ARx output from the amplification circuit 205 smaller than those of the other pulses.

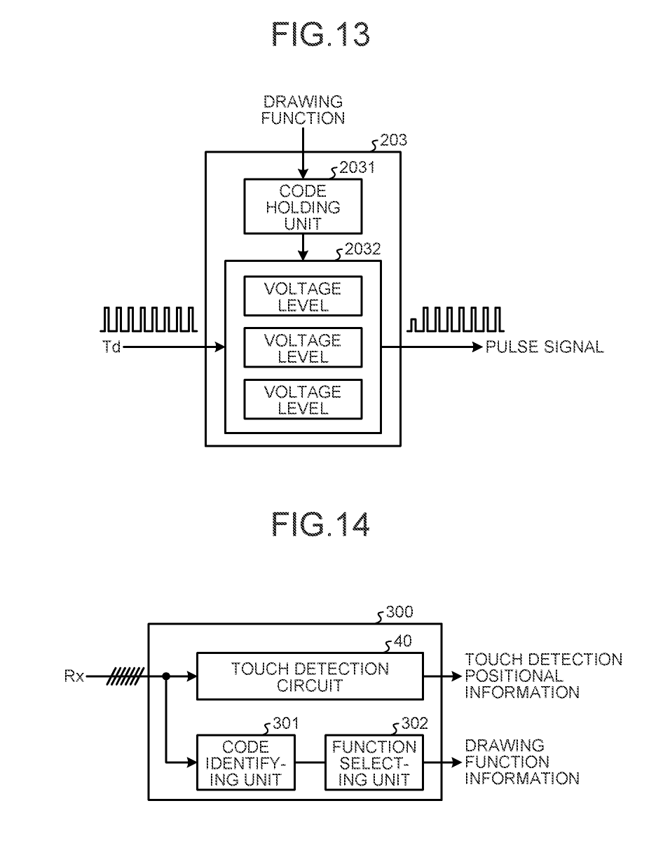

The following describes a specific example of a method for generating the generation signal ARx by the signal generating unit 207 with reference to FIGS. 10 to 13. FIG. 13 is a diagram of an exemplary configuration of the code applying unit according to the first embodiment.

When receiving the detection transmission signal Td from the detecting unit 201, the code applying unit 203 generates a multiple-valued (ternary, in this example) pulse signal corresponding to the drawing function selected through the interface 202 in synchronization with the pulses of the detection transmission signal Td, that is, the pulses “1” to “8” of the transmission signal Tx illustrated in FIG. 10.

As illustrated in FIG. 13, the code applying unit 203 includes a code holding unit 2031 and a voltage applying unit 2032. The code holding unit 2031 holds a plurality of codes. The voltage applying unit 2032 outputs a multiple-valued (ternary, in this example) voltage level corresponding to a pulse signal to be generated. The code holding unit 2031 outputs, to the voltage applying unit 2032, a code corresponding to a drawing function selected through the interface 202. The voltage applying unit 2032 uses the first pulse of the detection transmission signal Td, i.e., the pulse “1” of the transmission signal Tx illustrated in FIG. 10, as a trigger to select the voltage level corresponding to the code output from the code holding unit 2031 for each of the pulses “1” to “8” of the transmission signal Tx. As a result, the code applying unit 203 generates a multiple-valued (ternary, in this example) pulse signal corresponding to the code selected through the interface 202. The voltage applying unit 2032 may be a plurality of power supply circuits that output the respective voltage levels or a single power supply circuit that can select each voltage level.

The inversion circuit 204 inverts the pulse signal generated by the code applying unit 203. The amplification circuit 205 amplifies, at a predetermined amplification factor, the pulse signal inverted by the inversion circuit 204. As described above, the signal generating unit 207 generates the generation signal ARx (FIG. 12) including the code corresponding to the drawing function selected through the interface 202.

The output unit 206 is provided to the tip of the pointing device 200 similarly to the detecting unit 201. The output unit 206 outputs the generation signal ARx generated by the signal generating unit 207 to the intersection between the transmission electrode 600 and the reception electrode 700 via the capacitance (corresponding to C2′ in the basic principle of touch detection illustrated in FIGS. 1A and 1B to 4) formed between the tip of the pointing device 200 and the transmission electrode 600. As a result, the generation signal ARx generated by the signal generating unit 207 is superimposed on the reception signal Rx received by the touch control circuit 300 in the subsequent process. By superimposing the generation signal ARx on the reception signal Rx, it is possible to increase the accuracy in detection of a touch state created by the pointing device 200 even when the capacitance (corresponding to CT in the basic principle of touch detection illustrated in FIGS. 1A and 1B to 4) formed between the tip of the pointing device 200 and the transmission electrode 600 is low.

FIG. 14 is a diagram of an exemplary configuration of the touch control circuit in the display system with a touch detection function according to the first embodiment. The touch control circuit 300 includes a code identifying unit 301 and a function selecting unit 302 besides the drive electrode driver 14 and the touch detection circuit 40 illustrated in FIG. 5. In the example illustrated in FIG. 14, the drive electrode driver 14 is not illustrated.

The touch detection circuit 40 and the code identifying unit 301 receive the reception signal Rx on which the generation signal ARx is superimposed.

The code identifying unit 301 analyzes the reception signal Rx, thereby identifying the code included in the generation signal ARx superimposed on the reception signal Rx. The function selecting unit 302 holds codes corresponding to a plurality of preset drawing functions. The function selecting unit 302 selects a drawing function corresponding to the code identified by the code identifying unit 301 and outputs drawing function information. If the code identifying unit 301 determines that no code is included, that is, that all the pulses included in the reception signal Rx have the same value, the function selecting unit 302 outputs no drawing function information.

The touch detection positional information and the drawing function information output from the touch control circuit 300 are received by the main control circuit 500. Based on the touch detection positional information and the drawing function information output from the touch control circuit 300, the main control circuit 500 outputs, to the display control circuit 400, a control signal for carrying out the drawing function selected through the interface 202 of the pointing device 200 at the position on the liquid-crystal display device 20 corresponding to the touch detection position on the touch detecting device 30.

If the touch control circuit 300 outputs no drawing function information and only the touch detection positional information, the main control circuit 500 determines that the object that has performed the touch operation is an object other than the pointing device 200, such as the finger of the user. In this case, for example, the main control circuit 500 performs selection, movement, or another operation on an object displayed at the position on the liquid-crystal display device 20 corresponding to the touch detection position on the touch detecting device 30.

Let us assume a case where a touch operation performed by an object other than the pointing device 200, such as the finger of the user, is not allowed while the pointing device 200 is performing a touch operation, for example. In this case, if touches are detected at a plurality of positions, and a touch detected at one of the positions is determined to be made by the pointing device 200, the main control circuit 500 rejects the touch operations at positions other than the position at which the touch made by the pointing device 200 is detected. In other words, the main control circuit 500 can perform what is called a palm rejection function.

If the drawing function selected through the interface 202 of the pointing device 200 is “OFF”, the main control circuit 500 performs processing similar to the above mentioned processing, that is, the processing to be performed when the object that has performed the touch operation is an object other than the pointing device 200, such as the finger of the user. Specifically, the main control circuit 500 performs selection, movement, or another operation on an object displayed at the position on the liquid-crystal display device 20 corresponding to the touch detection position on the touch detecting device 30.

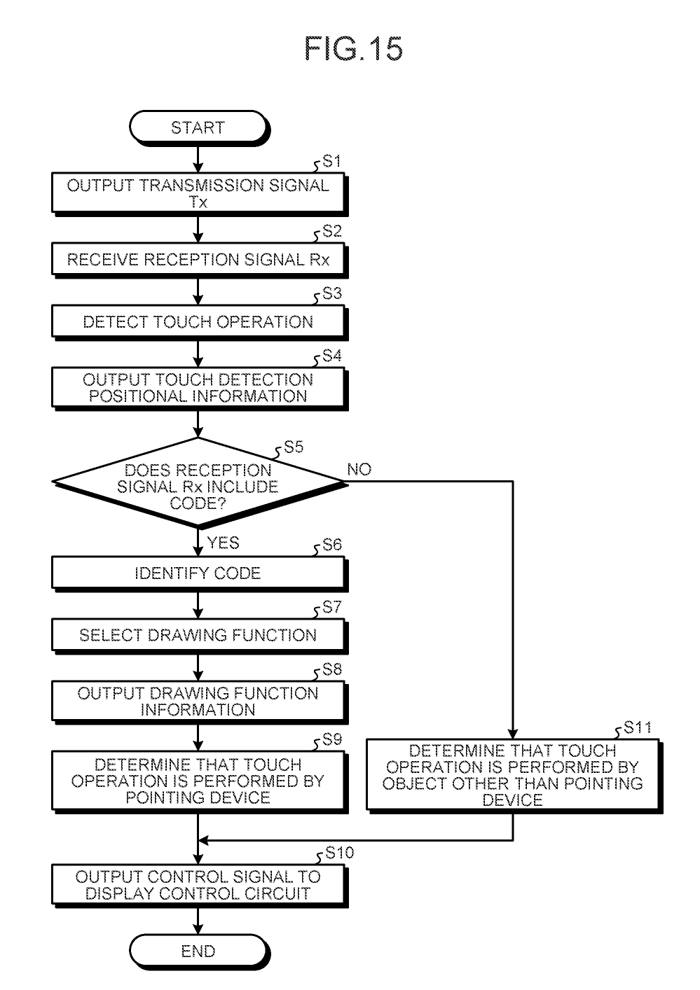

The following describes an example of a specific process performed by the display system 100 with a touch detection function according to the first embodiment. FIG. 15 is a flowchart of an example of a specific process performed by the display system with a touch detection function according to the first embodiment.

In a touch detection period, the touch control circuit 300 outputs the transmission signals Tx to the transmission electrodes 600 in a time-division manner, that is, so as to send a transmission signal Tx to the transmission electrodes one after another (Step S1). The touch control circuit 300 receives the reception signals Rx from the reception electrodes 700 (Step S2).

The touch control circuit 300 monitors the reception signals Rx received from the reception electrodes 700. When the touch detection circuit 40 detects a touch operation (Step S3), the touch detection circuit 40 outputs the touch detection positional information to the main control circuit 500 (Step S4). The code identifying unit 301 determines whether the reception signals Rx include a code (Step S5).

If the reception signals Rx include a code (Yes at Step S5), the code identifying unit 301 identifies the code included in the reception signals Rx (Step S6). The function selecting unit 302 selects a drawing function corresponding to the code identified by the code identifying unit 301 (Step S7) and outputs the drawing function information to the main control circuit 500 (Step S8).

Based on the touch detection positional information and the drawing function information output from the touch control circuit 300, the main control circuit 500 determines that a touch operation is performed by the pointing device 200 (Step S9). The main control circuit 500 outputs, to the display control circuit 400, a control signal for carrying out the drawing function selected through the interface 202 of the pointing device 200 at the position on the liquid-crystal display device 20 corresponding to the touch detection position on the touch detecting device 30 (Step S10). Subsequently, the process of the flowchart is terminated.

By contrast, if the reception signals Rx include no code (No at Step S5), the touch control circuit 300 outputs no drawing function information to the main control circuit 500. As a result, the main control circuit 500 determines that the object that performs the touch operation is an object other than the pointing device 200, such as the finger of the user (Step S11). The main control circuit 500 outputs, to the display control circuit 400, a control signal for carrying out processing corresponding to the touch operation performed by the object other than the pointing device 200, such as the finger of the user (e.g., selection, movement, or another operation performed on an object displayed at the position on the liquid-crystal display device 20 corresponding to the touch detection position on the touch detecting device 30) (Step S10). Subsequently, the process of the flowchart is terminated.

By performing the process described above, it is possible to perform the drawing function selected through the interface 202 of the pointing device 200 on the liquid-crystal display device 20.

While the drawing function that can be performed on the liquid-crystal display device 20 is selection of a color of a line drawn as a trajectory on the liquid-crystal display device 20 corresponding to a touch detection position of the pointing device 200 on the touch detecting device 30 in the example described above, it is not limited thereto. The drawing function may be selection of the width, the type, or another element of a line drawn as a trajectory of the pointing device 200 on the liquid-crystal display device 20, for example. Alternatively, the drawing function may be selection of an eraser function to erase an object displayed on the liquid-crystal display device 20 with a trajectory of the pointing device 200 on the liquid-crystal display device 20.

In the example described above, to indicate that the touch operation is performed by the pointing device 200, the code indicating the drawing function “OFF” illustrated in FIG. 12 is made such that the amplification factor of the pulse “1” in the transmission signal Tx illustrated in FIG. 10 is smaller than those of the other pulses. Alternatively, some of the pulses out of the pulses included in the transmission signal Tx may be used to generate identification codes corresponding to a plurality of pointing devices 200, for example. This configuration can make using a plurality of pointing devices 200 possible.

While the generation signal ARx including the ternary code illustrated in FIG. 12 is generated in the example described above, it is not limited thereto. A generation signal ARx including a multiple-valued code, such as codes of binary, quaternary, or more, may be generated. This configuration can transmit the reception signal Rx with more pieces of information superimposed thereon and thus perform various drawing functions.

As described above, the pointing device 200 in the display system with a touch detection function according to the first embodiment detects, from the transmission electrode 600, the transmission signal Tx including a plurality of pulses having the same peak value output from the touch control circuit 300. The pointing device 200 inverts and amplifies the transmission signal Tx in a manner making the amplification factors of some of the pulses included in the transmission signal Tx different from those of the other pulses. With this operation, the pointing device 200 generates the generation signal ARx including a binary or more code corresponding to the drawing function selected through the interface 202 in the pointing device 200 out of a plurality of types of predetermined drawing functions that can be performed on the liquid-crystal display device 20. The pointing device 200 outputs the generation signal ARx to the reception electrode 700 positioned on the touch detecting device 30 pointed by the pointing device 200. The touch control circuit 300 identifies the code included in the reception signal Rx, thereby selecting the drawing function corresponding to the code. The main control circuit 500 outputs, to the display control circuit 400, a control signal for carrying out the drawing function selected through the touch control circuit 300 at the position on the liquid-crystal display device 20 corresponding to the touch detection position on the touch detecting device 30. With this configuration, the display system with a touch detection function can perform the drawing function selected through the pointing device 200 at the position of the pointing device 200 on the liquid-crystal display device 20.

When no drawing function is selected, the pointing device 200 generates the generation signal ARx in a manner making the amplification factor of at least one of the pulses included in the transmission signal Tx different from those of the other pulses. It is thus possible to indicate that the touch operation at the touch detection position detected by the touch detection circuit 40 is performed by the pointing device 200. With this configuration, the display system with a touch detection function can distinguish the touch operation performed by the pointing device 200 from a touch operation performed by an object other than the pointing device 200, such as the finger of the user. Let us assume a case where a touch operation performed by an object other than the pointing device 200, such as the finger of the user, is not allowed while the pointing device 200 is performing a touch operation. In this case, if touches are detected at a plurality of positions, and a touch detected at one of the positions is determined to be made by the pointing device 200, the display system with a touch detection function can reject the touch operations at positions other than the position at which the touch made by the pointing device 200 is detected. In other words, the display system with a touch detection function can perform what is called a palm rejection function.

By setting the code to ternary or more, the display system with a touch detection function can transmit the reception signal Rx with more pieces of information superimposed thereon and thus perform various drawing functions.

The display system with a touch detection function may use a plurality of pulses out of the pulses included in the transmission signal Tx to generate identification codes corresponding to a plurality of pointing devices 200. With this configuration, the display system with a touch detection function can make a plurality of pointing devices 200 available.

By superimposing the generation signal ARx on the reception signal Rx, the display system with a touch detection function can increase the accuracy in detection of a touch state created by the pointing device 200 even when the capacitance formed between the tip of the pointing device 200 and the transmission electrode 600 is low.

The present embodiment can provide the display system 100 with a touch detection function that can perform various types of functions of one pointing device 200 having a plurality of types of functions simply by a touch operation.

### Second Embodiment

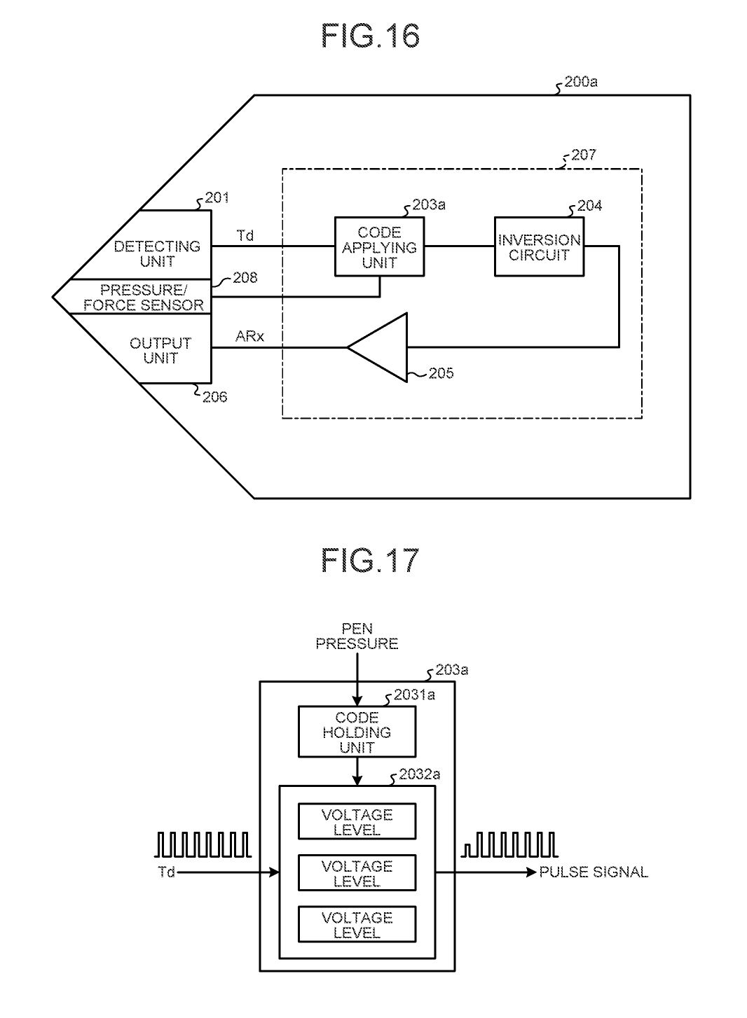

FIG. 16 is a diagram of an exemplary configuration of a pointing device in the display system with a touch detection function according to a second embodiment. Components identical with those described in the embodiment above are denoted by the same reference numerals and symbols, and overlapping explanation thereof will be omitted.

The present embodiment includes a pressure/force sensor 208 at the tip of a pointing device 200a instead of the interface 202 according to the first embodiment illustrated in FIG. 11. The pressure/force sensor 208 detects at least one of pressure or force as pen pressure. This configuration makes it possible to perform a drawing function to change the thickness of a line drawn as a trajectory of the pointing device 200a on the liquid-crystal display device 20 depending on the pen pressure, for example, as a drawing function performable on the liquid-crystal display device 20.

The method for generating the generation signal ARx by the signal generating unit 207 illustrated in FIG. 16 is the same as that in the first embodiment. FIG. 17 is a diagram of an exemplary configuration of a code applying unit according to the second embodiment. The following describes the method for generating the generation signal ARx according to the second embodiment with reference to FIGS. 16 and 17.

When receiving the detection transmission signal Td from the detecting unit 201, a code applying unit 203a generates a multiple-valued (e.g., ternary) pulse signal corresponding to the pen pressure detected by the pressure/force sensor 208 in synchronization with the pulses of the detection transmission signal Td, that is, the pulses “1” to “8” of the transmission signal Tx.

As illustrated in FIG. 17, the code applying unit 203a includes a code holding unit 2031a and a voltage applying unit 2032a. The code holding unit 2031a holds a plurality of codes. The voltage applying unit 2032a outputs a multiple-valued (e.g., ternary) voltage level corresponding to a pulse signal to be generated. The code holding unit 2031a outputs, to the voltage applying unit 2032a, a code corresponding to the pen pressure detected by the pressure/force sensor 208. The voltage applying unit 2032a uses the first pulse of the detection transmission signal Td, that is, the pulse “1” of the transmission signal Tx as a trigger to select a voltage level corresponding to the code output from the code holding unit 2031a for each of the pulses “1” to “8” of the transmission signal Tx. As a result, the code applying unit 203a generates a multiple-valued (e.g., ternary) pulse signal corresponding to the pen pressure detected by the pressure/force sensor 208. The voltage applying unit 2032a may be a plurality of power supply circuits that output the respective voltage levels or a single power supply circuit that can select each voltage level.

The inversion circuit 204 inverts the pulse signal generated by the code applying unit 203a. The amplification circuit 205 amplifies, at a predetermined amplification factor, the pulse signal inverted by the inversion circuit 204. As described above, the signal generating unit 207 generates the generation signal ARx including the code corresponding to the pen pressure detected by the pressure/force sensor 208.

The output unit 206 is provided to the tip of the pointing device 200a similarly to the detecting unit 201. The output unit 206 outputs the generation signal ARx generated by the signal generating unit 207 to the intersection between the transmission electrode 600 and the reception electrode 700 via the capacitance (corresponding to C2′ in the basic principle of touch detection illustrated in FIGS. 1A and 1B to 4) formed between the tip of the pointing device 200a and the transmission electrode 600. As a result, the generation signal ARx generated by the signal generating unit 207 is superimposed on the reception signal Rx received by the touch control circuit 300 in the subsequent process. By superimposing the generation signal ARx on the reception signal Rx, it is possible to increase the accuracy in detection of a touch state created by the pointing device 200a even when the capacitance (corresponding to C2′ in the basic principle of touch detection illustrated in FIGS. 1A and 1B to 4) formed between the tip of the pointing device 200a and the transmission electrode 600 is low.

In the example illustrated in FIG. 16, the pointing device 200a includes the pressure/force sensor 208 at the tip thereof instead of the interface 202 according to the first embodiment illustrated in FIG. 11. The pointing device 200a may include the interface 202 besides the pressure/force sensor 208.

As described above, the display system with a touch detection function according to the second embodiment includes the pressure/force sensor 208 at the tip of the pointing device 200a. With this configuration, the display system with a touch detection function can perform the drawing function to change the thickness of a line drawn as a trajectory of the pointing device 200a on the liquid-crystal display device 20 depending on the pen pressure, for example.

The display system with a touch detection function may include the interface 202 besides the pressure/force sensor 208. With this configuration, the display system with a touch detection function can perform a larger number of types of drawing functions than those of the first embodiment.

### Third Embodiment

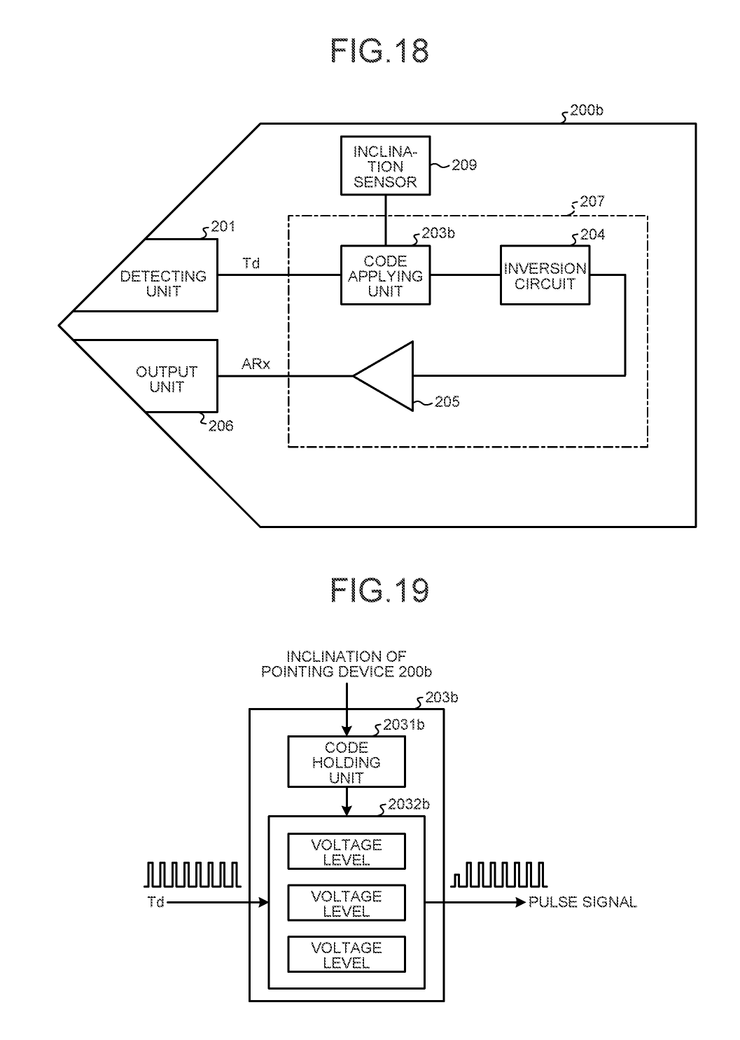

FIG. 18 is a diagram of an exemplary configuration of a pointing device in the display system with a touch detection function according to a third embodiment. Components identical with those described in the embodiments above are denoted by the same reference numerals and symbols, and overlapping explanation thereof will be omitted.

The present embodiment includes an inclination sensor 209 instead of the interface 202 according to the first embodiment illustrated in FIG. 11 and the pressure/force sensor 208 illustrated in FIG. 16. The inclination sensor 209 detects the inclination of a pointing device 200b. This configuration makes it possible to perform a drawing function to change the width of a line drawn as a trajectory of the pointing device 200b on the liquid-crystal display device 20 depending on the inclination of the pointing device 200b, for example, as a drawing function performable on the liquid-crystal display device 20.

The method for generating the generation signal ARx by the signal generating unit 207 illustrated in FIG. 18 is the same as that in the first and the second embodiments. FIG. 19 is a diagram of an exemplary configuration of a code applying unit according to the third embodiment. The following describes the method for generating the generation signal ARx according to the third embodiment with reference to FIGS. 18 and 19.

When receiving the detection transmission signal Td from the detecting unit 201, a code applying unit 203b generates a multiple-valued (e.g., ternary) pulse signal corresponding to the inclination of the pointing device 200b detected by the inclination sensor 209 in synchronization with the pulses of the detection transmission signal Td, that is, the pulses “1” to “8” of the transmission signal Tx.

As illustrated in FIG. 19, the code applying unit 203b includes a code holding unit 2031b and a voltage applying unit 2032b. The code holding unit 2031b holds a plurality of codes. The voltage applying unit 2032b outputs a multiple-valued (e.g., ternary) voltage level corresponding to a pulse signal to be generated. The code holding unit 2031b outputs, to the voltage applying unit 2032b, a code corresponding to the inclination of the pointing device 200b detected by the inclination sensor 209. The voltage applying unit 2032b uses the first pulse of the detection transmission signal Td, that is, the pulse “1” of the transmission signal Tx as a trigger to select a voltage level corresponding to the code output from the code holding unit 2031b for each of the pulses “1” to “8” of the transmission signal Tx. As a result, the code applying unit 203b generates a multiple-valued (e.g., ternary) pulse signal corresponding to the inclination of the pointing device 200b detected by the inclination sensor 209. The voltage applying unit 2032b may be a plurality of power supply circuits that output the respective voltage levels or a single power supply circuit that can select each voltage level.

The inversion circuit 204 inverts the pulse signal generated by the code applying unit 203b. The amplification circuit 205 amplifies, at a predetermined amplification factor, the pulse signal inverted by the inversion circuit 204. As described above, the signal generating unit 207 generates the generation signal ARx including the code corresponding to the inclination of the pointing device 200b detected by the inclination sensor 209.

The output unit 206 is provided to the tip of the pointing device 200b similarly to the detecting unit 201. The output unit 206 outputs the generation signal ARx generated by the signal generating unit 207 to the intersection between the transmission electrode 600 and the reception electrode 700 via the capacitance (corresponding to C2′ in the basic principle of touch detection illustrated in FIGS. 1A and 1B to 4) formed between the tip of the pointing device 200b and the transmission electrode 600. As a result, the generation signal ARx generated by the signal generating unit 207 is superimposed on the reception signal Rx received by the touch control circuit 300 in the subsequent process. By superimposing the generation signal ARx on the reception signal Rx, it is possible to increase the accuracy in detection of a touch state created by the pointing device 200b even when the capacitance (corresponding to C2′ in the basic principle of touch detection illustrated in FIGS. 1A and 1B to 4) formed between the tip of the pointing device 200b and the transmission electrode 600 is low.

In the example illustrated in FIG. 18, the pointing device 200b includes the inclination sensor 209 that detects the inclination of the pointing device 200b instead of the interface 202 according to the first embodiment illustrated in FIG. 11 and the pressure/force sensor 208 illustrated in FIG. 16. The pointing device 200b may include one or both of the interface 202 and the pressure/force sensor 208 besides the inclination sensor 209.

As described above, the display system with a touch detection function according to the third embodiment includes the inclination sensor 209 that detects the inclination of the pointing device 200b. With this configuration, the display system with a touch detection function can perform the drawing function to change the width of a line drawn as a trajectory of the pointing device 200b on the liquid-crystal display device 20 depending on the inclination of the pointing device 200b, for example.

The display system with a touch detection function may include one or both of the interface 202 and the pressure/force sensor 208 besides the inclination sensor 209. With this configuration, the display system with a touch detection function can perform a larger number of types of drawing functions than those of the first and the second embodiments.

### Fourth Embodiment

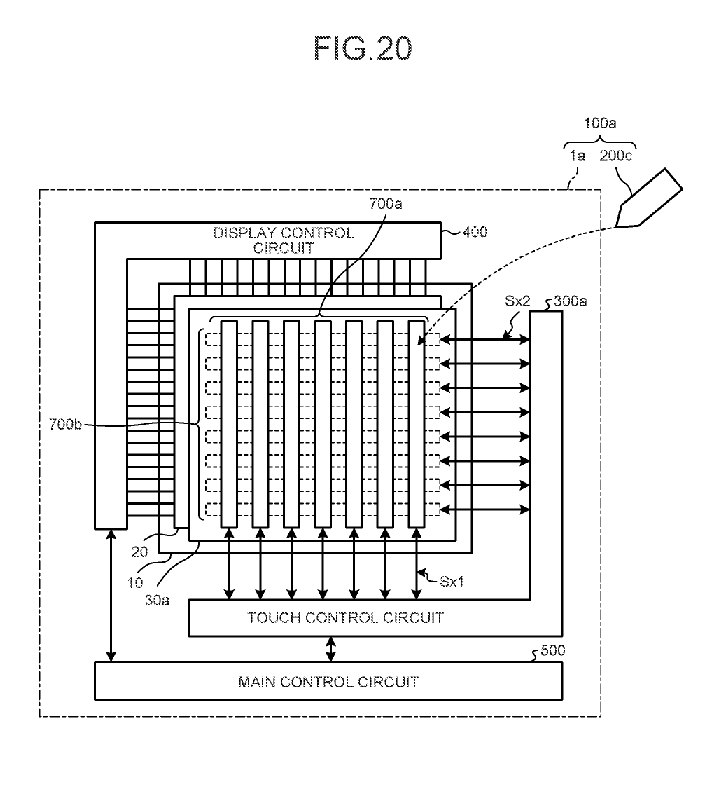

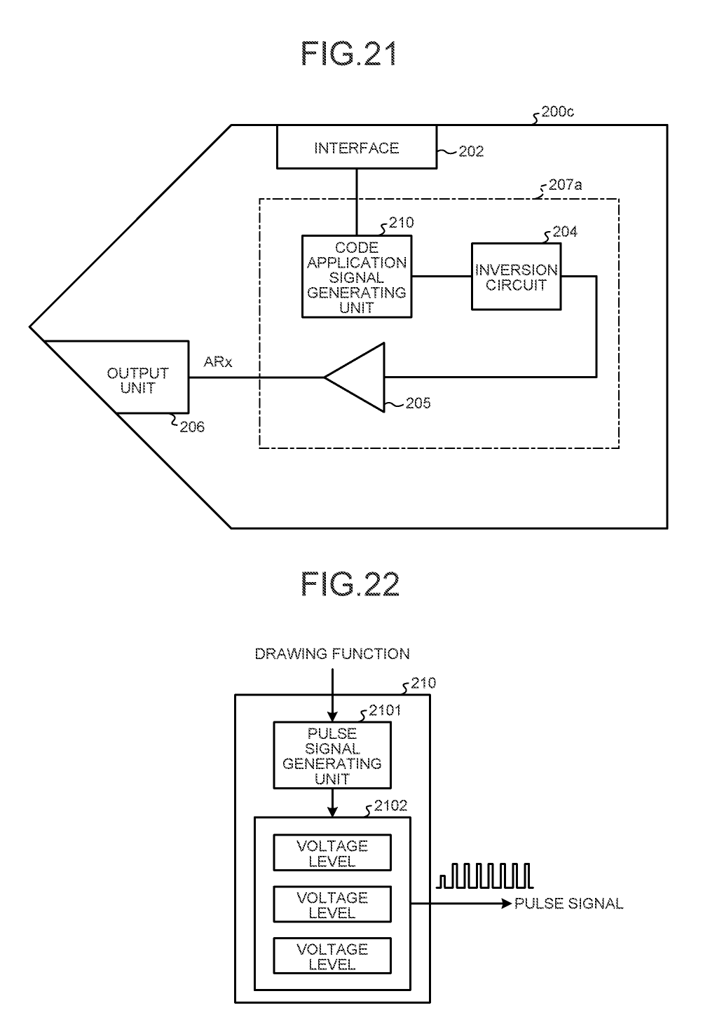

FIG. 20 is a diagram of an exemplary schematic configuration of a display system with a touch detection function according to a fourth embodiment. FIG. 21 is a diagram of an exemplary configuration of a pointing device in the display system with a touch detection function according to the fourth embodiment. Components identical with those described in the embodiments above are denoted by the same reference numerals and symbols, and overlapping explanation thereof will be omitted.

The touch detecting device 30 according to the first to the third embodiments is a mutual-type touch detecting device that detects a touch position based on a change in the capacitance at the intersections between the transmission electrodes 600 and the reception electrodes 700. As illustrated in FIG. 20, a touch detecting device 30a according to the present embodiment is a self-type touch detecting device that detects a touch position based on a change in the capacitance between a pointing device 200c serving as a detection target and detection electrodes 700a and 700b intersecting with each other.

A display system 100a with a touch detection function according to the present embodiment includes a display apparatus 1a with a touch detection function and the pointing device 200c. In the display system 100a with a touch detection function according to the present embodiment, the touch detecting device 30a includes a plurality of detection electrodes 700a and a plurality of detection electrodes 700b. The detection electrodes 700a are provided side by side in a manner extending in one direction, and the detection electrodes 700b are provided side by side in a manner extending in a direction intersecting with the detection electrodes 700a.

A touch control circuit 300a applies an alternating voltage to the plurality of detection electrodes 700a and the plurality of detection electrodes 700b, and detects the amplitude of both detection signals Sx1 from the detection electrodes 700a and detection signals Sx2 from the detection electrodes 700b.

The pointing device 200c includes the interface 202, a code application signal generating unit 210, the inversion circuit 204, the amplification circuit 205, and the output unit 206. The code application signal generating unit 210, the inversion circuit 204, and the amplification circuit 205 serve as a signal generating unit 207a.

The code application signal generating unit 210 holds a plurality of codes corresponding to drawing functions that can be performed on the liquid-crystal display device 20.

The code application signal generating unit 210 outputs a signal to which a code corresponding to a drawing function selected through the interface 202 is applied. The signal is inverted by the inversion circuit 204 and amplified by the amplification circuit 205 in the subsequent process, whereby the generation signal ARx is generated.

A part of the method for generating the generation signal ARx by the signal generating unit 207a illustrated in FIG. 21 is different from that in the first to the third embodiments. FIG. 22 is a diagram of an exemplary configuration of the code application signal generating unit according to the fourth embodiment. The following describes the method for generating the generation signal ARx according to the fourth embodiment with reference to FIGS. 21 and 22.

The code application signal generating unit 210 generates a multiple-valued (e.g., ternary) pulse signal corresponding to the code selected through the interface 202.

As illustrated in FIG. 22, the code application signal generating unit 210 includes a pulse signal generating unit 2101 and a voltage applying unit 2102, for example. The voltage applying unit 2082 outputs a multiple-valued (e.g., ternary) voltage level corresponding to a pulse signal to be generated. The pulse signal generating unit 2101 outputs, to the voltage applying unit 2102, a signal to which a code corresponding to the drawing function selected through the interface 202 is applied with a predetermined header pattern indicating the head of the code added before the code. The code of each drawing function includes no pattern the same as the header pattern. This configuration enables the touch control circuit 300a, which will be described later, to detect the header pattern.

The voltage applying unit 2102 uses the first pulse of the pulse signal generated by the pulse signal generating unit 2101 as a trigger to select a voltage level corresponding to the code output from the pulse signal generating unit 2101 for each of the pulses of the pulse signal. As a result, the code application signal generating unit 210 generates a multiple-valued (ternary, in this example) pulse signal corresponding to the code selected through the interface 202. The voltage applying unit 2102 may be a plurality of power supply circuits that output the respective voltage levels or a single power supply circuit that can select each voltage level.

The inversion circuit 204 inverts the pulse signal generated by the code application signal generating unit 210. The amplification circuit 205 amplifies, at a predetermined amplification factor, the pulse signal inverted by the inversion circuit 204. As described above, the signal generating unit 207a generates the generation signal ARx including the code corresponding to the drawing function selected through the interface 202 and the predetermined header pattern.

The output unit 206 is provided to the tip of the pointing device 200c. The output unit 206 outputs the generation signal ARx generated by the signal generating unit 207a to the intersection between the detection electrode 700a and the detection electrode 700b via the capacitance formed between the tip of the pointing device 200c and the detection electrodes 700a and 700b. As a result, the detection signals Sx1 and Sx2 received by the touch control circuit 300a in the subsequent process have waveforms on which the generation signal ARx generated by the signal generating unit 207a is superimposed. With this configuration, it is possible to increase the accuracy in detection of a touch state created by the pointing device 200c even when the capacitance formed between the tip of the pointing device 200c and the detection electrodes 700a and 700b is low.

While the pointing device 200c in the example illustrated in FIG. 21 includes the inversion circuit 204, it does not necessarily include the inversion circuit 204 in the case of the self-type touch detecting device according to the present embodiment. The presence of the inversion circuit 204 does not limit the present invention.

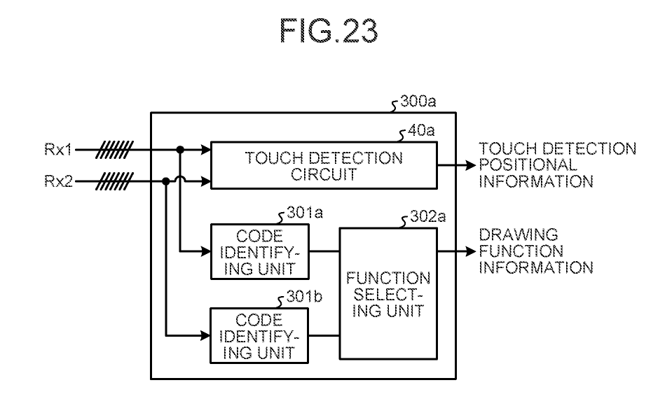

FIG. 23 is a diagram of an exemplary configuration of the touch control circuit in the display system with a touch detection function according to the fourth embodiment. The touch control circuit 300a includes a touch detection circuit 40a, a code identifying unit 301a, a code identifying unit 301b, and a function selecting unit 302a.

The touch detection circuit 40a receives the detection signals Sx1 and Sx2 to output the touch detection positional information.

When a header pattern included in the detection signal Sx1 is detected, the code identifying unit 301a identifies the code following the header pattern. When a header pattern included in the detection signal Sx2 is detected, the code identifying unit 301b identifies the code following the header pattern. The function selecting unit 302a holds codes corresponding to a plurality of preset drawing functions. The function selecting unit 302a selects a drawing function corresponding to a code identified by both the code identifying unit 301a and the code identifying unit 301b and outputs the drawing function information. The subsequent operations performed by the main control circuit 500 and the display control circuit 400 are the same as those in the first to the third embodiments.

While the pointing device 200c in the example described above includes the interface 202 similarly to the first embodiment, the pointing device 200c may include a pressure/force sensor at the tip thereof instead of the interface 202 similarly to the second embodiment or include both the interface 202 and the pressure/force sensor. Alternatively, the pointing device 200c may include an inclination sensor that detects the inclination of the pointing device 200c instead of the interface 202 similarly to the third embodiment or include both the interface 202 and the inclination sensor. Still alternatively, the pointing device 200c may include the interface 202, the pressure/force sensor, and the inclination sensor.

As described above, the pointing device 200c in the display system with a touch detection function according to the fourth embodiment outputs the generation signal ARx including the code corresponding to various types of drawing functions in a case where the touch detecting device 30a is a self-type touch detecting device. With this configuration, the present embodiment can provide the display system 100a with a touch detection function that can perform various types of functions of one pointing device 200c having a plurality of types of functions simply by a touch operation similarly to the case of the mutual-type touch detecting device according to the first to the third embodiments.

While the embodiments have been explained, the configurations of the embodiments above may be combined, and the contents described above are not intended to limit the present invention. Components according to the present invention include components easily conceivable by those skilled in the art, components substantially identical therewith, and what is called equivalents. The components described above may be appropriately combined, and various omissions, substitutions, and changes of the components may be made without departing from the spirit of the invention.

What is claimed is:

1. A display system with a touch detection function comprising a display apparatus with a touch detection function and a pointing device, wherein
the display apparatus with a touch detection function comprises:
a display device;
a touch detecting device that faces the display device and comprises a plurality of transmission electrodes arranged side by side in a manner extending in one direction and a plurality of reception electrodes arranged side by side in a manner extending in a direction intersecting with the transmission electrodes, capacitance being formed between the transmission electrodes and the reception electrodes; and
a control circuit that outputs a transmission signal including a plurality of pulses having the same peak value to the transmission electrodes and detects a position of at least the pointing device on the touch detecting device based on a reception signal received from each of the reception electrodes to display the position on the display device,
the pointing device is used to indicate the position on the touch detecting device,
the pointing device holds a plurality of codes of binary or more corresponding to a plurality of predetermined drawing functions performable on the display device, detects the transmission signal transmitted from the transmission electrodes, generates a generation signal by, based on the codes, inverting and amplifying the transmission signal with an amplification factor of at least one pulse out of the pulses being different from amplification factors of other pulses, and outputs the generation signal to the reception electrodes, and
the control circuit identifies a code included in the generation signal and performs a drawing function corresponding to the code at the position of the pointing device on the display device.

2. The display system with a touch detection function according to claim 1, wherein the pointing device includes an interface for setting the codes of binary or more corresponding to the drawing functions on the pointing device.

3. The display system with a touch detection function according to claim 1, wherein the pointing device holds a code of binary or more corresponding to a drawing function to set a color of a line drawn as a trajectory of the pointing device on the display device corresponding to a touch detection position on the touch detecting device.

4. The display system with a touch detection function according to claim 1, wherein the pointing device holds a code of binary or more corresponding to a drawing function to set a width of a line drawn as a trajectory of the pointing device on the display device corresponding to a touch detection position on the touch detecting device.

5. The display system with a touch detection function according to claim 1, wherein the pointing device holds a code of binary or more corresponding to a drawing function to erase an object displayed on the display device with a trajectory of the pointing device on the display device corresponding to a touch detection position on the touch detecting device.

6. The display system with a touch detection function according to claim 1, wherein
the pointing device comprises a sensor that detects at least one of pressure and force between the pointing device and the touch detecting device, and holds a code of binary or more corresponding to a drawing function to change a thickness of a line drawn as a trajectory of the pointing device on the display device corresponding to the touch detection position on the touch detecting device depending on the magnitude of the at least one of the pressure and force detected by the sensor.

7. The display system with a touch detection function according to claim 1, wherein
the pointing device comprises an inclination sensor that detects inclination of the pointing device on the display device, and holds a code of binary or more corresponding to a drawing function to change a width of a line drawn as a trajectory of the pointing device on the display device corresponding to a touch detection position on the touch detecting device depending on the inclination detected by the inclination sensor.

8. The display system with a touch detection function according to claim 1, wherein identification codes corresponding to a plurality of the pointing devices are generated using a plurality of pulses included in the generation signal.
